(19) United States
(12) Patent Application Publication
(10) Pub. No.: US 2008/0091598 A1
(43) Pub. Date: Apr. 17, 2008

(54) Method and system of executing an action on a portable data storage device

(76) Inventor: Daniel Fauleau, Mondeville (FR)

Correspondence Address: LOWE HAUPTMAN & BERNER, LLP, 1700 DIAGONAL ROAD, SUITE 300, ALEXANDRIA, VA, 22314, US

(21) Appl. No.: 11/581,573

(22) Filed: Oct. 17, 2006

(51) Int. Cl. G06Q 40/00

(52) U.S. Cl. 705/41

(57) ABSTRACT

A method of and system for executing an action on a portable data storage device via a network, the method comprising the steps of: requesting, at a remote terminal, an action to be executed on the portable data storage device; transmitting the request from the remote terminal to a central server via the network; storing data representative of the action requested in a memory of the central server; transmitting data representative of the action to one or more portable data storage interface devices; presenting the portable data storage device to a portable data storage interface device of the one or more data storage interface devices; executing the action on the portable data storage memory device.

### FIELD OF INVENTION

The present invention relates to a system for executing an action requested remotely by a user, on a portable data storage device, and related methods and apparatus. Particularly, but not exclusively the invention relates to a system for remotely requesting an action such as transfer of a monetary value or transfer of a ticket to a smart card and managing a plurality of requested actions.

### BACKGROUND OF THE INVENTION

A smart card, chip card, or integrated circuit(s) card (ICC), is a pocket-sized card usually about the size of a credit card generally comprising one or more memory chips or integrated circuits for receiving and storing data. The memory chips may be read-only or have a read/write capability. A smart card may be of the “contact” type in which the memory chip makes contact with electrical connectors that can read information from the chip and write information back to the chip. Another type of smart card is a contactless smart card, in which the chip communicates with the card reader by electromagnetic waves, for example, using RFID induction technology.

Smart cards are used in a wide range of applications for example, as credit cards and electronic cash in banking, as payment cards for pay phones, as access cards, as loyalty cards, for security systems and identification and as travel cards. A travel smart card may, for example, store data corresponding to a monetary value which may be debited according to the journeys taken by a user, an authorized geographical zone of travel, an expiration date etc.

In known transport systems a user purchases a smart card from a public transport operator for travel on a particular transport network such as an underground metro network. The user can charge his or her card with a monetary value, a ticket such as a season ticket or a ticket for a particular journey, at a ticket vending machine or a ticket kiosk operated by the public transport operator from whom he or she purchases the smart card.

A drawback of such a system is that the user must present himself at a ticket vending machine or kiosk in order to charge his smart card with a ticket or monetary value. Another drawback of such a system is that the user may only use his smart card on one transport network. If, for example, the user travels to another town or region, he or she must buy a new smart card in order to use the transport network of that region.

### SUMMARY OF THE INVENTION

The present invention has been devised with the foregoing in mind.

In a first aspect the invention provides a method of executing an action on a portable data storage device via a network, the method comprising the steps of: requesting, at a remote terminal, an action to be executed on the portable data storage device; transmitting the request from the remote terminal to a central server via the network; storing data representative of the action requested in a memory of the central server; transmitting data representative of the action to one or more portable data storage interface devices; presenting the portable data storage device to a portable data storage interface device of the one or more data storage interface devices; and executing the action on the portable data storage memory device.

The requested action may involve adding a product authorizing a journey on a transport network to the portable data storage device, writing a monetary value to the portable data storage device; removing a monetary value from the portable data storage device; or blocking the portable data storage device so that a journey on public transport cannot be authorized.

The method may include indicating on the portable data storage device that the action has been executed so that if the portable data storage device is presented to another portable data storage interface device or to the same portable data storage interface device the action is not executed more than once.

The method may include storing data on the portable data storage interface device indicating that the action has been completed.

In a second aspect of the invention there is provided a system for executing an action on a portable memory device, the system comprising: a central server comprising at least one memory for storing a plurality of actions, each action being associated with an individual portable data storage device; a user terminal in communication with said central server, the user terminal comprising a web browser for enabling communication with said server via a network; and an access device comprising reading means for reading an identification code from the portable storage device and processing means for executing the action on the portable storage device.

Such a system can thus help to reduce the need to employ agents to man ticket kiosks or to reduce the required number of automatic ticket machines which have the disadvantage that they are prone to vandalism. Since a user can request an action to be executed remotely, he or she does not have to go to a station in order to charge his or her smart card and instead can do so from the comfort of his or own home.

Furthermore, the system and method allow transactions between action issuers i.e. a service provider issuing an action and receiving or giving payment for execution of the action and action bearers i.e. a service provider executing the action to be managed centrally by a Credit Clearing House System CCHS.

The remote user terminal may be any device such as a workstation, portable computer (such as a laptop, PDA or mobile phone) or an ATM machine, for example. The central server may be accessed via an internet connection or a telephone call centre for example.

The portable data storage device may be a smart card or a swipe card.

In a related aspect of the invention, there is provided a server comprising input means (such as a network interface) for receiving a request to execute an action the request including card identification data; storing means (such as a hard disk or a database stored within a storage medium) for storing data representative of the action to be executed and the card identification data and output means (such as a network interface) for outputting one or more actions to an access terminal for performing the action.

The present invention can be implemented in any convenient form, for example using dedicated hardware, or a mixture of dedicated hardware and software. The present invention is particularly suited to implementation as computer software implemented by a workstation or laptop computer. The network, can include any wide area or even local area, conventional terrestrial or wireless communications network. The systems may comprise any suitably programmable apparatuses such as a general purpose computer, personal digital assistant, mobile telephone (such as a WAP or 3G-compliant phone) and so on. Aspects of the present invention encompass computer software implementable on a programmable device. The computer software can be provided to the programmable device using any conventional carrier medium. The carrier medium can comprise a transient carrier medium such as an electrical, optical, microwave, acoustic or radio frequency signal carrying the computer code. An example of such a transient medium is a TCP/IP signal carrying computer code over an IP network, such as the Internet. The carrier medium can also comprise a storage medium for storing processor readable code such as a floppy disk, hard disk, CD ROM, magnetic tape device or solid state memory device.

Although each aspect and various features of the present invention have been defined hereinabove independently, it will be appreciated that, where appropriate, each aspect can be used in any combination with any other aspect(s) or features of the invention.

Embodiments of the present invention will now be described, by way of example only, with reference to the accompanying drawings, in which:

### BRIEF DESCRIPTION OF THE DRAWINGS

FIG. 1 is a schematic diagram of a system according to a first embodiment of the present invention;

FIG. 2 is a schematic diagram of the components of a remote user terminal in accordance with the first embodiment of the present invention;

FIG. 3 is a schematic diagram of the components of a central server in accordance with the first embodiment of the present invention;

FIG. 4 is a schematic diagram of the components of an intermediate server in accordance with the first embodiment of the present invention;

FIG. 5 is a schematic diagram of the components of an access gate in accordance with the first embodiment of the present invention;

FIG. 6 is a flowchart illustrating the execution of a operation in the system shown in FIG. 1;

FIG. 7 is a schematic diagram of a system according to a second embodiment of the invention; and

FIG. 8 is a flowchart illustrating the execution of a operation in the system shown in FIG. 7.

### DETAILED DESCRIPTION OF THE DRAWINGS

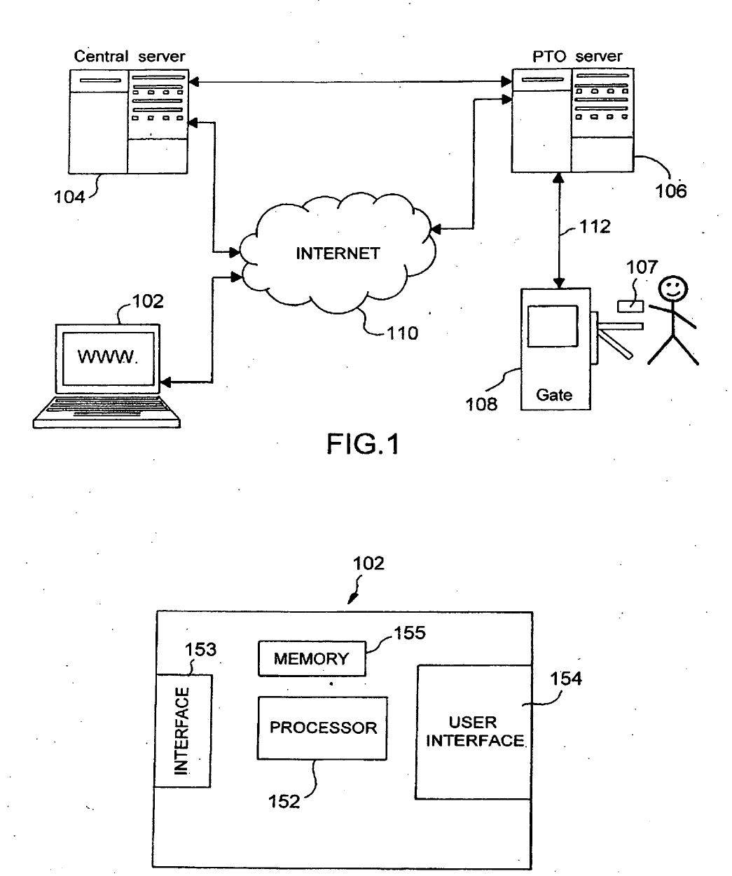

A first embodiment of the system will now be described with references to FIGS. 1 to 5.

In FIG. 1 a user terminal 102, a central processing server 104, an intermediate server such as a Public Transport Operator (PTO) server 106 communicate via a network 110 such as the Internet. An access gate 108 to a transport network such as a metro network or train platform is connected to the PTO server 106 via a wireless or cabled link 112.

The remote user terminal 102 will now be described in more detail with reference to FIG. 2. The remote user terminal may be any device such as a workstation, conventional PC, a portable computer (such as a laptop, PDA or mobile phone) or an ATM machine, for example. In FIG. 2 the components of the remote user terminal 102 are shown; The terminal 102 comprises a processor 152, a network interface 153, user interface 154 such as a keyboard and program memory 155. A data memory (not shown) may additionally be provided. The program memory 155 contains executable code for carrying out the operations of the remote terminal as described herein. The remote terminal 102 is provided with a web browser enabling the user to communicate with a web server of the central server 104 or directly with a web server of the intermediate server 106 in order to remotely request an action to be executed on a specific smart card. For example, the user may request a monetary value to be added to an e-purse stored on his or her smart card or may request a ticket such as a return train, bus or air ticket to a specific destination to be added to the smart card.

Although only one user terminal is illustrated in FIG. 1, it will be appreciated that in reality a number of user terminals can be connected to the network 110.

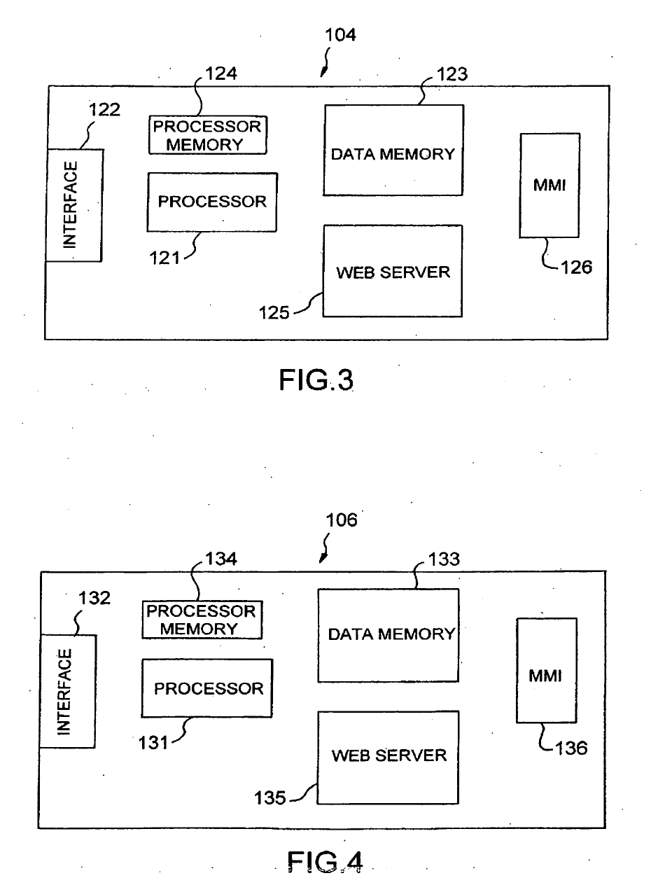

The components of the central processing server 104 of FIG. 1 will now be described with reference to FIG. 3. The server 104 comprises a processor 121, a network interface 122, a data memory 123, a program memory 124, a web server 125 and a man machine interface (MMI) 126. The data memory 123 is a mass storage device in which data representing a plurality of actions requested by one or more users may be stored in a database in the form of a list or otherwise. The program memory 124 contains executable code for carrying out the operations of the server 104 as described herein. The web server 125 enables a user to communicate with the central server 104 by using a web browser.

In variants of this embodiment the processor 121 may comprise a plurality of processors, which may be provided within a plurality of computer systems. The network interface 122 may also be divided into a plurality of interfaces suitable for connecting the server 104 a plurality of devices. The server 104 may further comprise dedicated cryptographic hardware and/or software components. Various components may be included or removed from the server as appropriate.

Although data memory 123 is illustrated in FIG. 3 is a single unit, it will be appreciated that the data memory 123 may comprise a plurality of data memory units. It will be further understood that in alternative embodiments of the invention the data memory 123 may be located at a location remote to the server 104.

The following data corresponding to a requested action may be stored in data memory 123:
serial number of smart card associated with request;
date of expiration of action;
action type;
description of action (field list depending on the type of action);
action issuer
action bearer;
region identification number;
Order identification number;
payment associated with action;
   In the context of the present invention an action may comprise one of the following:
adding a product such as a ticket or fare corresponding to a desired journey to a smart card;
adding a monetary value to a smart card;
removing a product from a smart card
activating or deactivating an auto-reload function on a smart card;
refunding a product instance on a smart card and
blocking or unblocking an e-purse on the smart card.
[Peut-on ajouter d'autres types d'actions?]
   In the context of the present invention the term “Action list” defines data representing one or more actions for execution on a corresponding portable memory device such as a smart card. Each action of the action list may be associated with an action requested from a remote terminal or may be an action added directly at the central server. Each action is associated with a smart card. An action list may be stored on the central server and transmitted to intermediate servers and/or directly to access devices capable of executing the requested action.

An Action List stored in the database of the data memory 123 can be managed via one or Man Machine Interface devices (MMI) 126. The MMI 126 may be a keyboard or any other suitable device used to access the data of the server. The following operations may be performed via the MMI:
consulting the action list;
adding a new action to the action list
deleting an action from the action list such as an action that has already been completed;
searching for a specific item within the action list, using, for example the identification number of the smart card associated with the requested action;
filtering the action list for purposes of consultation by the type of action requested or smart card ID;
providing a report associated with the current status of the action list such as a report on the actions completed during a specific time period such as a day or a week.

An expiration date may be associated with each action stored within the action list on the database. The action may then be flagged at expiration to prevent the action being distributed to a PTO or access device.

The action list may be sorted according, for example, to the card number, the action type, the action issuer, the action bearer, the date of expiration or the card activity

One or more action lists stored in the database of the central server 104 can be downloaded to the PTO server 106.

THE PTO server 106 will now be described with reference to FIG. 4. The server 106 comprises a processor 131, a network interface 132, a data memory 133, a program memory 134, a web server 135 and a man machine interface MMI 136. The data memory 133 is a mass storage device in which an action list may be stored. As before, program memory 124 contains executable code for carrying out the operations of the server as described herein. The web server 135 enables communication with a user using a web browser. Thus a user can request an action directly at the PTO server.

An action list comprising one or more actions can be downloaded to the database from the central server and stored in data memory 133. The action list may be managed via the MMI 136 in a similar way to the management of the action list on the central server 104 as described above.

Although in this embodiment data memory 133 is located locally to the PTO server 106, in alternative embodiments the data memory may be located remotely to the PTO server 106.

The PTO server 106 communicates with access gate 108 through a network 112. The PTO server can download an action list comprising one or more actions to the gate 108 and upload an action list from the gate 108 or any other access device to which it is connected, and upload an action list to or receive an action list from the central server 104.

It will be understood that in alternative embodiments of the invention, the access gate may communicate with the PTO server through the network 110 or may be directly connected to the PTO server without passing through a network.

Although FIG. 1 illustrates only one PTO server in communication with the central server 104, it will be understood that a number of PTO servers can be connected to the central server 104.

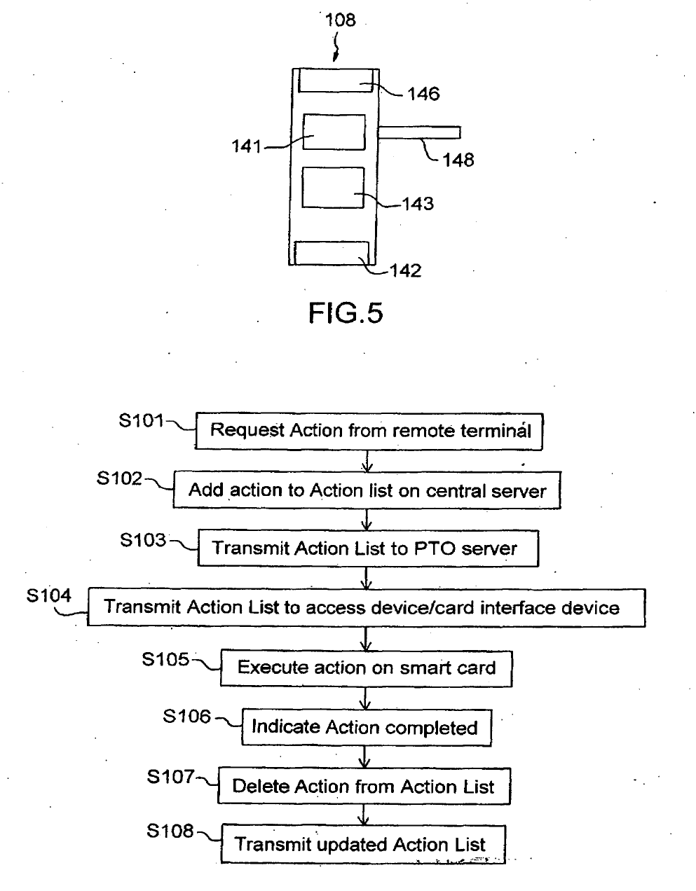

Access gate 108 will now be described with reference to FIG. 5. The access gate 108 acting as a portable data storage interface device comprises a processor 141, a data interface 142, a data memory 143, a smart card reader 146 and a barrier 148. The reader 146 is configured to read a contactless or a contact smart card. The access gate 108 may be located, for example, at an entrance to a transport system such as a underground metro to allow a cardholder entry to the transport network. To gain entry to the transport network smartcard 107 is presented to the reader 146 of access gate 108. The reader 146 reads the identification number or serial number of the smart card. If there is action among the plurality of actions (device action list) stored in the data memory 143 of the access gate 108 corresponding to the card identification number the action will be executed on the card if the action has not already been executed by the access gate 108 or by another portable data storage interface device such as another access gate, a check in device, a validator, a ticket vending machine (TVM) or ticket kiosk. The action may involve downloading a ticket or a monetary value to the smart card thereby authorizing the user to pass through the gate 108 and gain entry to a transport system. In this case the processor 141 processes the data in such a way that the barrier 148 lets the user pass through.

If there are further actions on the action list stored in the data memory 143 of the access device 108 corresponding to the card identification number of the smart card these further actions may also be executed when the smart card is presented to the access device. For example, a ticket for travel on another transport network or corresponding to another journey on the same network may also be downloaded to the smart card if this action has not already been executed by this or any other access device to which the action has been downloaded. Operation of the system will now be described with reference to FIG. 6.

FIG. 6 outlines an example of an operation used to remotely request and execute an action on a smart card using the system of FIG. 1.

In step S101, from the remote terminal 102, using a web browser to communicate with the central server 104, a user requests an action to be executed on a previously purchased smart card 107 such as a smart card for authorizing journeys on one or more transport networks. Using the user interface 154 the user inputs data to identify the smart card such as an identification number. The user may also be required to input a PIN (personal identification number) and/or any other security data in order to validate the card.

The user may, for example, request one or more of the following actions to be executed on the card:
add a product such as a ticket or fare corresponding to a desired journey to the card;
add a monetary value to the card;
remove a product from the card
activate or deactivate an auto-reload function on the card; and
block or unblock an e-purse on the card.

Payment for execution of the action may be made by charging the purchase to a credit card or bank account by for example inputting a credit card number and date of expiration. The user can thus purchase one or more transit tickets for various methods of transportation such as rail, bus, metro or air or add a specific amount of money i.e. add a monetary value to an e-purse associated with the card. If required a receipt of purchase may be provided by printing.

In Step S102, data representing the action requested by the user is stored in a database of the data memory 123 of the central server 104, for example the action may be added to an action list comprising actions previously requested by the same user or by other users.

In step S103 the action list is then sent by the server 104 to one or more PTO servers including PTO server 106.

In step S104 each public transport operator receiving the Action List can then download the action list to card interface devices under its control such as a check in devices, access gates, kiosks, ticket vending machines, validation devices such as a hand held validator.

In step S105 when the user presents the card at an access device such as a check in device, an access gate, ticket kiosk, ticket vending machine, or validation device the requested action can be executed, for example a monetary value or a ticket is downloaded and written to the smart card. Other requested actions from the device action list corresponding to that smart card may also be written to the smart card if the actions have not already been executed by that or any other access device.

In step S106a, a flag associated with the corresponding action is set on the device action list stored in the memory of the access device to indicate that the relevant action has been completed.

In step S106b, in order to ensure that the requested action is only executed once on the smart card the following procedure is implemented. Each action of the action list is associated with an order identification number (Order_ID). The first time an action is requested for an individual smart card the Order_ID associated with that action on the card is set at 1. Each time a further action is requested for the same card the Order_ID set for the further action is calculated as follows:

New Order Id for card x=Previous Order_ID used for card x+1

The Order_id of each action associated with the smart card and stored on the card interface device is compared with a value stored on the smart card called the Last_Served_Order, the Last_Served_order being the order identification number of the last action executed on the card. For each action in an action list if the Order_ID of the action is greater than the corresponding Last_Served_Order in the card, the action can be executed and the Last_Served_Order will be overwritten by the Order_ID associated with this action, i.e the Last_Served_Order will be set at the Order_ID of the last executed action. If, however, the Order_ID of an action is less than the Last_Served_Order, then the action will not be executed since it is indicated that it has already been executed.

This process ensures that when the same smart card is presented to another access device storing the requested action or to the same access device again the action will not be executed again.

It will be appreciated that in alternative embodiments of the invention alternative methods known to the skilled person in the art may be used to indicate or flag on the card that the action has already been completed.

At the end of a predetermined period of time such as at the end of a day a device action List can be transmitted from each access device to the PTO server 106. The action list will comprise completed actions and pending actions (actions not yet completed). The PTO server can merge the various device action lists to form one PTO server action list comprising completed and/or pending actions. In step S107 completed actions can be deleted from the Action List at the PTO server and an updated list may be sent from the PTO server to the Central server and downloaded to the access devices in step S108. The central server 104 can manage the updated list as described above. If the central server receives device action lists from various PTO servers, these actions lists can be merged into a global action list comprising completed and/or pending actions.

In alternative embodiments of the invention, completed actions may be deleted at the central server and an updated Action list may be prepared at the Central server. An updated Action list can then be transmitted from the central server to the PTO servers and then transmitted to the relevant access devices.

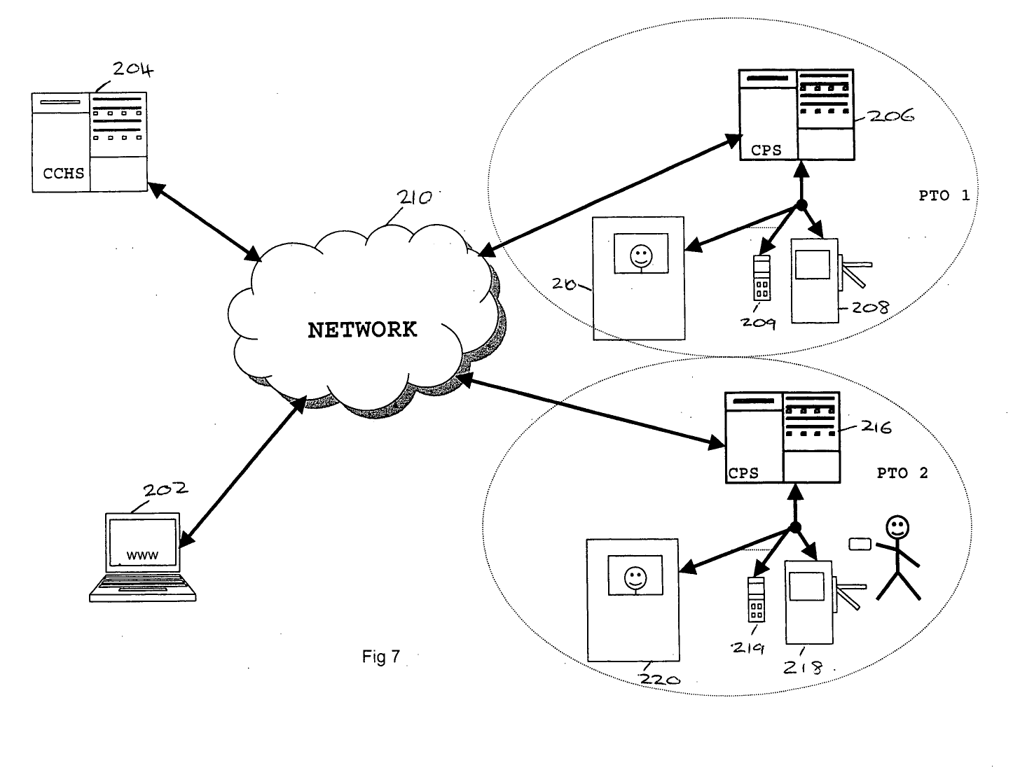

A second embodiment of a system in accordance with the present invention will now be described with reference to FIG. 7.

In FIG. 7 a user terminal 202, a central server, 204, a first service provider server 206, a second service provider server 216 communicate via a network 205.

The user terminal 202 is similar to the user terminal of the previous embodiment and operates in a similar way. A user may request an action by using a web browser to communicate with the web server of the central server 204 or with a web server of the first service provider server 206 or a web server of the second service provider 216.

Again it will be appreciated that more than one user terminal will be connected to the network.

The central server 204 includes similar components and operates in a similar way to the central processing server of the previous embodiment as described above. The central server 204 may, for example, be associated with a central clearing house system (CCHS) being responsible for settling payments between various service providers according to where tickets or travel credit have been bought—i.e from an action issuer—and where the travel credit or ticket has been used—i.e by an action bearer. The central server 204 can communicate with a number of servers under the control of various service providers. Although FIG. 7 only illustrates two service provider networks in communication with the central server 204 it will be appreciated that the central server 204 will, in general, be configured to communicate with a greater number of service provider networks.

A list of actions recorded in the database of a memory of server 204 can be managed via a MMI to
add an action;
search for an action;
filter the action list;
delete an action;
print a report such as the list of actions completed in a predetermined time period such as within the last day or the last week, the list of pending actions or the result of a filtering operation.

An expiration date may be associated with each action stored within the action list on the database. The action may then be flagged at expiration to prevent the action being distributed to a service provider or access device. The system can be configured to automatically delete each completed action one week after completion of the relevant action.

The action list stored at the central server 204 comprises the following information corresponding to each action:
card chip serial number associated with action;
date of expiration of action;
action type;
description of action (field list depending on the type of action);
action issuer
action bearer;
region identification;
Order identification;

The actions in the action list at the central server may thus be sorted according to any of the above criteria, for example by the region where they are likely to be executed, the action bearer, i.e. the service provider providing the service e.g. a transport service, associated with the action, the smart card serial number, the type of action etc.

In addition, action lists received from different service provider servers or from different access devices within the different service providers may be merged together to form one global Action List. The global Action List may be sorted into sub lists according to service provider, region etc.

The system allows a regionalization strategy to be defined for the global Action List based on customer choice and the type of action requested. The following criteria may be used to sort the actions within the global action list into:
actions to be downloaded to the whole network;
actions to be downloaded to a set of service providers;
actions to be downloaded to a dedicated region.

A region may correspond to a geographical region such as a town, a national area such as a state, a station, or a group of service providers or a group of selected access devices within one or more service providers. A region may be defined in the central server by:
a region name;
a region ID;
one or more geographical zones;
a collection of service providers;
a collection of Station or depot processing systems (SPS/DPS); or
a collection of card interface devices.

In this way the number of actions in an Action List stored in each individual access device may be kept to a minimum. Only actions associated with smart cards likely to be presented to an access device may be downloaded to that access device. There is no need to download an action to an access device which is unlikely to interface with the smart card in question. For example, if the user requests a ticket for a journey on a local transport network in one town there may be no need to download the action to an access device located at the entry to a local transport network in another town located in another state or region. In general, each access device can manage up to 3000 actions at the same time. In alternative embodiments the access device may be able to manage a greater or lesser number of actions at the same time.

An Action List (global including all actions or regional including actions specific to a region) can be downloaded from the central server 204 to the selected service provider central servers on a regular basis such as every night. The central server 204 is also configured to receive a number of service provider Action Lists indicating completed actions on a regular basis from the service provider servers.

A CCHS can thus clear, settle and apportion transactions, resulting from a completed action, between service providers i.e. between an action issuer and an action bearer.

The first service provider server 206 and the second service provider server 216 operate in a similar way to the PTO server of the previous embodiment as described above. The first service provider servers 206 and 216 can carry out a few additional functions which will be described below.

The first service provider server 206 and the second provider server 216 are configured to manage one or more requests received from a user terminal 202 and to add a requested action to the corresponding service provider action list. The first service provider server 206 and the second provider server 216 can receive an action list (global or regional action list) from the central server 204 and merge it with its own service provider action list. In addition the first and second service provider servers can send a respective service provider action list to the central server 204. The first service provider server 206 and the second provider server 216 can also receive device action lists from access devices 208, 209, 210 and 218, 219 and 220, respectively and merge received device action lists into a service provider action list.

A service provider action list stored at first service provider 206 and the second service provider 216 comprises the following information:
card chip serial number;
date of expiration of action;
action type;
description of action (field list depending on the type of action);
action issuer
action bearer;
region ID;
Order ID;

The first service provider server 206 and the second provider server 216 can manage the respective service provider action list to:
add a new action to the action list
search for a specific action within the action list
filter the action list by, for example, the card serial number or the action type
delete an action from the action list
supply a specific report linked to the action list, for example, a specific report grouping all the transactions resulting from actions of the respective service provider action list.

The service provider action list can be sorted by decreasing card activity during a period of time such as a week. The list can then be sent directly from the service provider server to the access devices or may be transmitted to the access devices via an intermediate server such as a depot or station processing system (DPS or SPS).

A regionalization strategy of the respective service provider Action List may be defined according to customer choice and the type of action. It is possible to define for each action in the respective service provider action list the region to which it can be downloaded. An action may be downloaded to the whole service provider network or to a dedicated region within the service provider network.

A protection mechanism may be implemented by the first service provider server 206 and the second provider server 216 to prevent certain actions being uploaded to the central server for diffusion to other service providers. For example, if a service provider provides special rates to a client, that service provider may not wish those rates to be known by competitor service providers. Thus, the service provider may prevent the associated action being uploaded to the central server for diffusion to other service providers.

Access gates 208 and 218 are similar to the access gate of the previous embodiment and operate in a similar way. Validators 209 and 219 and ticket vending machines operate in a similar way to read the serial number of a smart card pand to execute the associated action.

The elapsed time between the registration of an action at the central server and an access device performing the action is usually less than 24 hours.

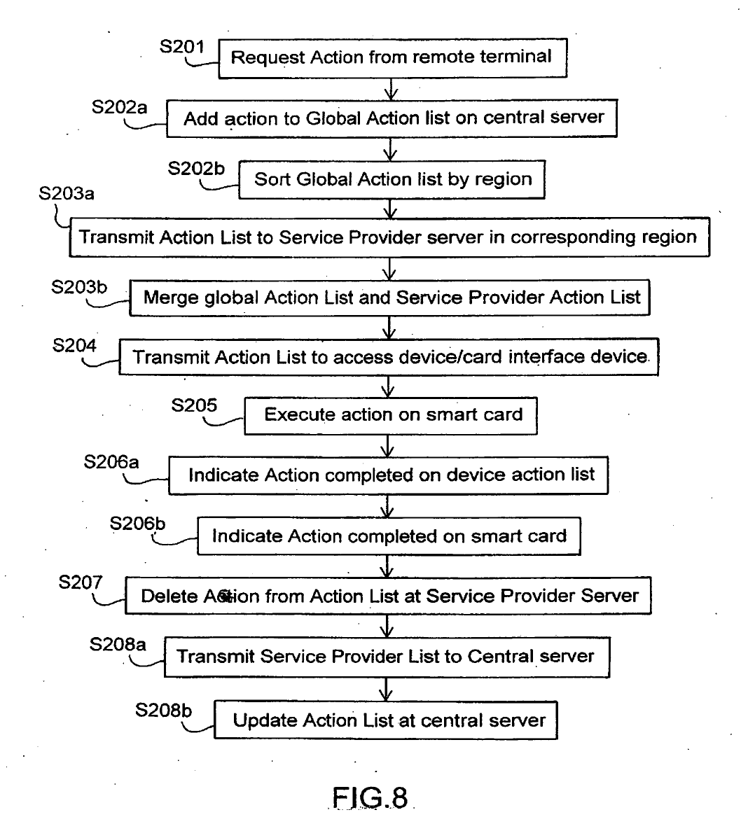

FIG. 8 outlines an example of an operation used to remotely request and execute an action on a smart card using the system of FIG. 7.

In step S201, from the remote terminal 202, using a web browser to communicate with a first provider server 206, a second server provider server 216, or with a web server of the central server 204, a user requests an action to be executed on a previously purchased smart card in a similar way to step S101 of the previous embodiment.

As before, the user, may for example, request one or more of the following actions to be executed on the card:
add a product such as a ticket or fare corresponding to a desired journey to the card;
add a monetary value to the card;
remove a product from the card
activate or deactivate an auto-reload function on the card; and
block or unblock an e-purse on the card.

Payment for execution of the action may be made by charging the purchase to a credit card or bank account by for example inputting a credit card number and date of expiration.

The user may, for example, request that a fare corresponding to a desired journey with the first service provider and/or a fare corresponding to a desired journey with the second service provider (and/or any other service provider in communication with the central server) be added to his smart card. Alternatively, the user may request that a monetary value that can be used in exchange for services on one or both service providers be downloaded to the smart card.

In step S202a, data representing the action requested by the user is stored in a database of the central server in a list of pending actions. The following data corresponding to the action will be stored in the database:
card chip serial number;
date of expiration of action;
action type;
description of action (field list depending on the type of action);
action issuer
action bearer;
region ID;
Order ID;

The global action list stored on the central server may include the action requested by the user, pending actions requested by other users or the same user and actions added by the central management.

In step 202b the global action list is sorted by the central server into
actions to be downloaded to all service providers;
actions to be downloaded to a selected group of service providers; and
actions to be downloaded to a dedicated region.

A region may be defined by: a region name;
a region ID;
one or more geographical zones;
a collection of Station or depot processing systems (SPS/DPS); or
a collection of card interface devices.

In step S203a an action list is transmitted from the central server 204 to the first service provider server 206 and the second service provider server 216. The transmitted action list may be a global action list comprising all actions or a regional action list comprising actions corresponding to a particular region and excluding actions corresponding with other regions.

In step S203b the first service provider server 206 merges the action list received from the central server 204 with its own action list created at the first service provider server. Similarly, the second service provider server 216 merges the action list received from the central server 204 with its own action list created at the second service provider server.

In step S204a before sending the merged service provider action list to access devices the service providers 206 and 216 may filter the actions in the respective service provider action list according to further regions and according to card activity. In order to limit the number of actions sent to an access device the number of actions may be limited to a predetermined number and for example actions beyond 3000 actions may not be transmitted. By sorting the lists prior to transmission to the access devices by card activity it can be ensured that actins corresponding to those cards used most frequently will be transmitted to the access devices. By limiting the number of actions being sent to access devices network activity and access device storage requirements can be reduced.

In step 204b the first service provider 206 transmits an action list to access devices 208, 209 and 210 and the second service provider 216 transmits an action list to access devices 218, 219 and 220.

In alternative embodiments of the invention the first service provider service may transmit the action list to a selected set of station processing systems which in turn transmit the appropriate actions to the corresponding access devices. again the station processing systems may implement a regionalization strategy so that actions may b filtered according to region and sent to the appropriate region.

In step S205 when the user presents the card at any of the access devices the requested action is executed, for example, a monetary value or a ticket is downloaded and written to the smart card. Other requested actions may also be written to the smart card if the actions have not already been executed by that or any other access device.

In step S206a, in a manner similar to step S106a, a flag associated with the corresponding action is set on the action list stored in the memory of the access device to indicate that the relevant action has been completed. A similar process to the method of S106b of the previous embodiment is used in step S206b to indicate on the card that the action has been completed.

At the end of a predetermined period of time such as at the end of a day a device Action List can be transmitted from each access device to the respective service provider server 206 or 216. In step S207 completed actions can be deleted from the service provider action List at the corresponding service provider and an updated service provider action list may be sent from the first and second service provider server 206 and 216 to the central server 204 in step S208a. Any actions which the service provider wishes to remain confidential may not be transmitted to the central server 204 for national diffusion.

In step S208b the central server merges the action lists received from service provider servers 206 and 216 to form an updated global list, adds newly requested actions to the action list and updates the global action list. The Action list can be managed and sorted at the central server 204 as described before. An updated global action list can then be sent to the service provider servers for transmission to the access devices.

At the central server of a CCHS a transfer of funds between service providers can be managed according to the action issuer and the action provider for each action.

In an alternative embodiment of the invention the first and/or second service provider server may transmit the action list to intermediate servers such as station or depot processing systems which in turn transmit the appropriate actions to the corresponding access devices. The action list can be managed at the intermediate server to filter the actions by region, to sort the actions by card activity, card serial number, to limit the number of actions downloaded to access devices to 3000, for example, cutting off the list at 3000. The intermediate server may be located in a station which is part of a service provider network. The intermediate server may communicate with a plurality of access devices including an access gate, a validator, and a ticket vending machine.

Although in the above embodiments the user requests the action by using a computer containing a web browser, in alternative embodiments of the invention the user my request the action by telephoning to a call center where the action corresponding to the request may be input manually to the server or automatically, for example, by using voice recognition software. The call center may be associated with the central server or with the service provider server.

While the above embodiments have been described in relation to transport systems it will be appreciated that the present invention may be used in other applications such as ticketing for sporting events, concerts, entry into museums, cinemas etc.

Further modifications lying within the spirit and scope of the present invention will be apparent to a skilled person in the art.

1. A method of executing an action on a portable data storage device via a network, the method comprising the steps of:
requesting, at a remote terminal, an action to be executed on the portable data storage device;
transmitting the request from the remote terminal to a central server via the network;
storing data representative of the action requested in a memory of the central server;
transmitting data representative of the action to one or more portable data storage interface devices;
presenting the portable data storage device to a portable data storage interface device of the one or more data storage interface devices; and
executing the action on the portable data storage memory device.

2. A method according to claim 1 wherein the action comprises adding a product authorizing a journey on a transport network to the portable storage memory device.

3. A method according to claim 1 wherein the action comprises writing a monetary value to the portable storage memory device.

4. A method according to claim 1 wherein the action comprises removing a monetary value from the portable storage memory device.

5. A method according to claim 1 wherein the action comprises blocking the portable storage memory device so that a journey on public transport cannot be authorized.

6. A method according to claim 1 further comprising indicating on the portable data storage device that the action has been executed so that if the portable data storage device is presented to another portable data storage interface device or to the same portable data storage interface device the action is not executed more than once.

7. A method according to claim 1 further including storing data on the portable data storage interface device indicating that the action has been completed.

8. A method according to claim 7 further comprising transmitting the data indicating that the action has been completed to the central server.

9. A method according to claim 7 further comprising transmitting the data indicating that the action has been completed to an intermediate server.

10. A method according to claim 8 further comprising transmitting the data indicating that the action has been completed to a plurality of portable data storage interface devices.

11. A method according to claim 1 wherein the data representing a plurality of actions is stored in the form of a list.

12. A method according to claim 1 wherein the action is transmitted to one or more intermediate servers before being transmitted to one or more portable data storage interface devices.

13. A method according to claim 12 wherein the action is transmitted to a subgroup of portable data storage interface device according to the region in which the portable data storage interface device are located.

14. A system for executing an action on a portable memory device, the system comprising:
a central server comprising at least one database for storing a plurality of actions, each action being associated with an individual portable data storage device;
a user terminal in communication with said central server, the user terminal comprising a web browser for enabling communication with said server via a network; and
an access device comprising reading means for reading an identification code from the portable storage device and processing means for executing the action on the portable storage device.

15. A system according to claim 14, wherein the access device is one of a gate, a ticket vending machine and a validator.

16. A system according to claim 14, wherein the user terminal is a personal computer.

17. A server comprising
means for receiving a request to execute an action the request including card identification data;
storing means for storing data representative of the action to be executed and the card identification data;
processing means for managing the stored data; and
output means for outputting one or more actions to an access terminal for performing the action.

18. A portable data storage device for use with the system of claim 14.

19. A portable data storage device according to claim 18, wherein the portable data storage device is a smart card.

20. A carrier medium carrying computer readable code for controlling a computer to carry out the method of claim 1.
